(19) United States
(12) Patent Application Publication
(10) Pub. No.: US 2008/0107948 A1
(43) Pub. Date: May 8, 2008

(54) High Specific Power Solid Oxide Fuel Cell Stack

(75) Inventor: Jean Yamanis, Hartford, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED Technologies Corporation, Hartfoed, CT (US)

(21) Appl. No.: 11/793,621

(22) PCT Filed: Dec. 21, 2005
(86) PCT No.: PCT/US05/46233

§ 371 Date: Jun. 19, 2007

Related U.S. Application Data
(60) Provisional application No. 60/637,945, filed on Dec. 21, 2004.

(51) Int. Cl. H01M 8/10; B23K 11/00; B23K 15/00; B23K 20/00; B23K 26/20; H01M 8/02

(52) U.S. Cl. 429/33; 219/117.1; 219/121.35; 219/121.85; 228/177; 429/30; 429/34; 429/35

(57) ABSTRACT

A metallic, rigidized foil support structure (11) supports a cell (14) of a solid oxide fuel cell (10). The support structure (11) includes a separator sheet (18), a support sheet (16) having perforations (26) configured to communicate a fluid, and a porous layer (20) positioned between the separator sheet (18) and the support sheet (16). The porous layer (20) provides support and reinforcement to the support structure (11) as well as an electrical connection between the support sheet (16) and the separator sheet (18). Fuel flows through the porous layer (20).

### BACKGROUND OF THE INVENTION

Solid oxide fuel cell (SOFC) development has historically focused on high operating temperatures (900-1000° C.) with the intention that the SOFCs could be integrated into large-scale stationary power plants. The steam that is produced by the high operating temperatures is used to drive endothermic fuel processing reactions via heat exchangers and is also typically channeled to turbines to generate more electricity, improving the overall efficiency of the stationary power generation unit. In addition, SOFCs do not require pure hydrogen to operate and can run on hydrocarbon fuels that produce carbon monoxide, which acts as a fuel to the electrodes in the fuel cells.

Current SOFCs typically need to run at the high operating temperatures to reach temperatures at which yttria-stabilized zirconia (YSZ) electrolytes, the electrolytes commonly used in SOFCs, are sufficiently conductive. Due to the high operating temperatures required to run SOFCs, some SOFC materials are currently formed of ceramic, which while capable of withstanding high temperatures, is brittle and prone to breakage if mishandled. A reduction in operating temperature can enable the consideration of base metals for use as SOFC materials. In particular, ferritic stainless steels are an ideal choice when considering thermal expansion and electron conducting scale characteristics. However, the kinetics of oxidation of ferritic stainless steel are too fast at temperatures above 650 degrees Celsius (° C.). While it is possible to use properly coated ferritic stainless steel at high temperatures, the metal will have to be of substantial thickness in order to mitigate the oxidation/corrosion processes at temperatures where YSZ is sufficiently conductive.

The YSZ electrolytes are typically supported by the anode of the fuel cell, which is a very porous and relatively weak structure, and has a useful thickness in the range of 350 to 1500 microns (μm) for large cell footprints, i.e. greater than 200 square centimeters. The cell stack specific power, i.e., the hypothetical specific power (SP) of the anode-supported, YSZ-electrolyte cell stack, is roughly proportional to the area power density divided by the anode thickness. Thus, the SP can be increased by either increasing the power density or reducing the anode thickness. However, for large cell footprints, reducing the anode thickness to less than 350 μm is difficult to achieve as the brittle ceramic cells are prone to fracture. Additionally, as the cell footprint increases, process yield decreases.

Advancements have focused on SOFC operation at lower temperatures in an effort to reduce cost and to expand the applicability of SOFCs. Lower operating temperatures increase the range of materials that can be used to construct the device, increase material durability and overall robustness, and significantly lower cost. There is thus great interest in creating intermediate temperature SOFCs with operating temperatures below 600° C.

An alternative to using YSZ electrolytes is using gadolinia-doped ceria (GDC) electrolytes in SOFCs. One problem with using GDC is that at temperatures greater than 600° C., the partial reduction of ceria in the fuel atmosphere produces an internal short circuit in the fuel cell that degrades performance. However, at temperatures less than 600° C., the reduction of Ce⁴⁺ to Ce³⁺ is minimal and can be neglected under fuel cell operating conditions in the temperature range of 500-600° C.

### BRIEF SUMMARY OF THE INVENTION

A metallic, rigidized foil support structure supports a cell of a solid oxide fuel cell. The support structure includes a separator sheet, a support sheet having perforations configured to communicate a fluid, and a porous layer located between the separator sheet and the support sheet. The porous layer provides support and reinforcement to the support structure as well as an electrical connection between the support sheet and the separator sheet. Fuel flows through the porous layer.

### BRIEF DESCRIPTION OF THE DRAWINGS

FIG. 1 is a schematic, cross-sectional view of a solid oxide fuel cell supported by a metal support structure.

FIG. 2A is a schematic, cross-sectional view of a rigidized foil support structure.

FIG. 2B is a schematic, cross-sectional view of the metal support structure.

FIG. 2C is a schematic, cross-sectional view of the metal support structure rotated 90 degrees from the view shown in FIG. 2B.

FIG. 3 is a schematic, cross-sectional view of a cell deposited on the metal support structure.

FIG. 3A is a schematic, magnified cross-sectional view of the cell and a perforated sheet of the rigidized foil support structure.

FIG. 4 is a schematic, magnified perspective cross-sectional view of two stacked solid oxide fuel cells.

FIG. 5 is a schematic of the chemical reactions at the solid oxide fuel cell.

FIG. 6A is a schematic, cross-sectional view of the solid oxide fuel cell stack.

FIG. 6B is a schematic, cross-sectional view of the solid oxide fuel cell stack rotated 90 degrees from the view shown in FIG. 6A.

### DETAILED DESCRIPTION

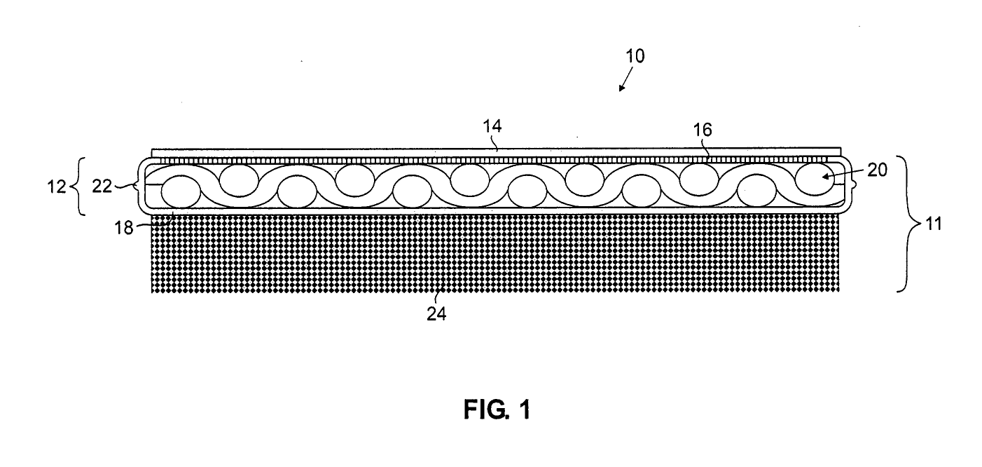

FIG. 1 represents a ceria-based solid oxide fuel cell (SOFC) 10 that generally includes metal support structure 11 and thick-film tri-layer cell 14. Metal support structure 11 generally includes rigidized foil support (RFS) 12, metallic joints 22, and cathode interconnect 24. RFS 12 supports cell 14 and includes support sheet 16, separator sheet 18, and anode interconnect 20. RFS structure 12 and cell 14 of SOFC 10 form a very compact and light-weight structure with a total thickness of between approximately 0.04 millimeters (mm) and approximately 0.06 mm. SOFC 10 with metal support structure 11 is capable of operating at temperatures below approximately 600 degrees Celsius (° C.), allowing for higher potential specific power, low cost manufacturing techniques, use of cost-effective materials, robustness, durability, and rapid start-up times.

SOFC 10 has increased durability with the capability to run for times in excess of 40,000 hours. Due to its lightweight structure, SOFC 10 can also be more rapidly heated than current state-of-the-art solid oxide fuel cells. For example, SOFC 10 can potentially be heated to approximately 600° C. in about five minutes at a ramp rate of approximately 110° C. per minute. SOFC 10 also has an increased potential specific power (SP), measured in Watts per gram (W/g) or kilowatts per kilogram (kW/kg). For a very thin ceramic cell, the SP is equal to the area power density (Watts per square centimeter, W/cm²) divided by the area mass density (g/cm²) of RFS 12. For example, when SOFC 10 has an area power density of 0.2 W/cm² and RFS structure 12 has an area mass density of 0.2 g/cm², SOFC 10 has a SP of approximately 1 W/g. At an area power density of 0.4 W/cm², SOFC 10 has a SP of approximately 2 W/g. This is significantly higher than the SP of current state-of-the-art fuel cell stacks having the same area power density. Although the actual SP value of a cell stack decreases when fuel manifolds and current collector plates are taken into account, the effects of these variables decrease with increased RFS footprint and increased nominal cell stack power capacity.

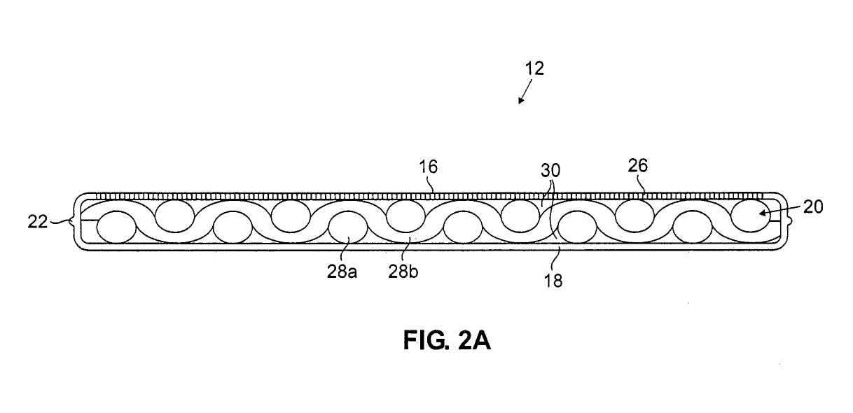

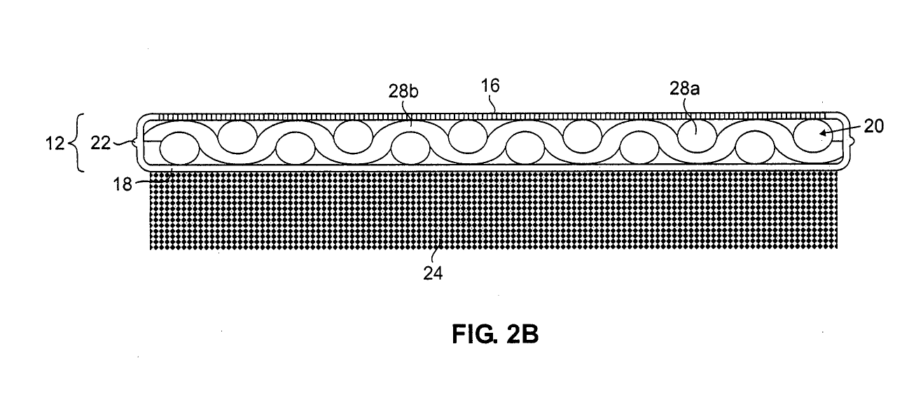

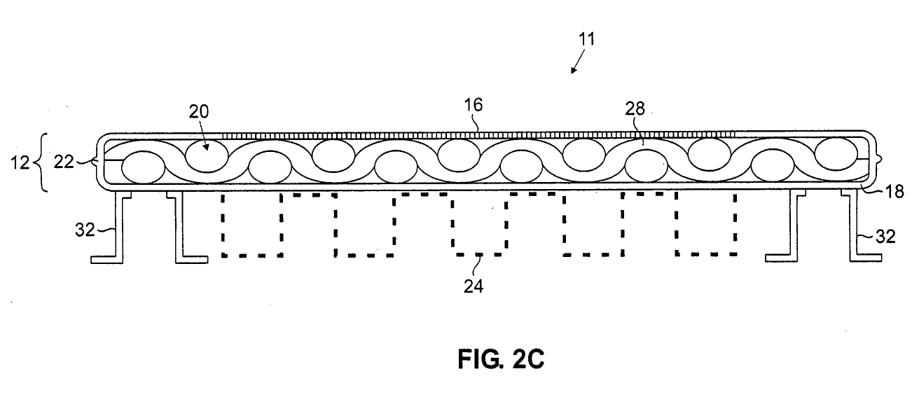

FIG. 2A shows RFS 12, which includes support sheet 16, separator sheet 18, and anode interconnect 20. Support sheet 16 of RFS 12 is a thin and ductile sheet of metal or foil that directly supports cell 14. Support sheet 16 contains a plurality of perforations 26 over a substantial portion of support sheet 16. In one embodiment, support sheet 16 has a thickness of approximately 0.015 mm and is formed of stainless steel. Examples of suitable stainless steels include, but are not limited to: ferritic stainless steel, high-chromium stainless steel, and the like. Examples of suitable commercially available ferritic stainless steels include, but are not limited to: E-BRITE, available from Allegheny Ludlum Corporation, Pittsburgh, Pa. and Crofer 22 APU, available from ThyssenKrupp, Düsseldorf, Germany. Support sheet 16 may also be formed of other stainless steels as long as the stainless steel has a coefficient of thermal expansion similar to the coefficient of thermal expansion of ceramic cell 14. Examples of other suitable ferritic stainless steels are grade 409 stainless steels, titanium stabilized ferritic stainless steels, and other 400 series stainless steels. The coefficients of thermal expansion of support sheet 16 and cell 14 must be similar in order to minimize thermal stresses that can lead to fracture of ceramic cell 14.

Separator sheet 18 is a thin, solid sheet of metal or foil and is positioned between anode interconnect 20 and cathode interconnect 24 (shown in FIG. 2B). Separator sheet 18 prevents gases flowing through anode interconnect 20 from interacting with gases flowing through cathode interconnect 24. Although FIG. 2A discusses support sheet 16 and separator sheet 18 as being two different sheets of metal, support sheet 16 and separator sheet 18 can be formed from a single sheet of metal. In one embodiment, separator sheet 18 has a thickness of approximately 0.015 mm and is formed of the same material used to form support sheet 16.

Anode interconnect 20 is located between support sheet 16 and separator sheet 18 to provide support and reinforcement to RFS 12 and to provide electrical connection between support sheet 16 and separator sheet 18. Anode interconnect 20 is also highly porous, presenting very low resistance to fuel flow through RFS 12. In one embodiment, anode interconnect 20 is comprised of a plurality of elongated wires or filaments 28 and is thus very light and thin. Filaments 28 include a first set of filaments 28a and a second set of filaments 28b, with each filament 28 of first and second sets of filaments 28a and 28b positioned parallel to other filaments 28 of their respective set. Second set of filaments 28b is then positioned perpendicular to first set of filaments 28a. Filaments 28b of second set of filaments 28b weave above and below adjacent filaments 28a of first set of filaments 28a to form a wire weave pattern, such as a wire mesh structure or fabric. The wire weave pattern of filaments 28 can be a square weave or any wire weave or mesh known in the art. Fuel containing hydrogen gas, such as a reformate or syngas composition derived from processed hydrocarbon fuels, flow through void spaces 30 between first and second sets of filaments 28a and 28b and provide oxidizable chemicals for electrochemical reactions. In one embodiment, anode interconnect 20 is formed of the same material used to form support sheet 16 and separator sheet 18 and has a thickness of approximately 0.2 mm or greater. Anode interconnect 20 can also be formed of other metallic materials having sufficient structural integrity to provide support and reinforcement to RFS 12, sufficient electrical conductivity to minimize Ohmic losses, and sufficient porosity to minimize the pressure drop of fuel flow. The material must also allow for electron flow across its structure, be oxidation-resistant and stable in the fuel environment, and have a coefficient of thermal expansion similar to the other materials used to fabricate RFS 12 to minimize deformation. In one embodiment, anode interconnect 20 can have the geometry of a relief structure and can be an integral part of support sheet 16 or separate sheet 18 of RFS 12. A relief structure is a three-dimensional structure that extends above a reference plane. The relief structure can be formed by any suitable metal forming or chemical process.

Metallic joints 22 are formed between the ends of support sheet 16 and separator sheet 18 and form a hermetic seal for the fuel stream around the periphery of RFS 12. The hermetic seals of RFS 12 provide reliable separation of the fuel and oxidant gas streams flowing through SOFC 10 (shown in FIG. 1) and provide a high level of robustness to thermal stresses. Optionally, metal support structure 11 can be formed without metallic joints 22, in which case a hermetic seal can be formed around the periphery of RFS 12 by suitable glass or glass-ceramic materials.

To fabricate RFS 12, perforations 26 are first formed in support sheet 16 to make support sheet 16 porous. Perforations 26 may be formed in support sheet 16 by any suitable methods known in the art, including, but not limited to: laser beam drilling, electron beam drilling, photochemical etching, and other suitable micromachining processes. Anode interconnect 20 is then positioned between support sheet 16 and separator sheet 18. Support sheet 16, anode interconnect 20, and separator sheet 18 are then diffusion bonded into a single structure in a high-vacuum furnace under an optimum mechanical load to provide rigidity to RFS structure 12, establish low-electrical resistance, and form durable metallic joints 22 between support sheet 16 and separator sheet 18. In the diffusion-bonding process step, filaments 28 of anode interconnect 20 bond to each other, support sheet 16, and separator sheet 18, establishing strong connections with minimal resistance to electron flow. If support sheet 16 and separator sheet 18 are formed from a single sheet of metal, half of the single sheet is perforated and half of the single sheet remains solid. Anode interconnect 20 is then positioned between the perforated half and the solid half and the single sheet of metal is folded in half to encase anode interconnect 20. The single sheet of metal and anode interconnect 20 are then diffusion bonded as described above. RFS 12 can also be bonded by welding processes known in the art, such as resistance seam welding and brazing with compatible filler materials.

After separator sheet 18, anode interconnect 20, and support sheet 16 are bonded together, any overhang portions of support sheet 16 and separator sheet 18 are brought together by a suitable metal-working process, such as stamping, and are subsequently laser-beam welded, electron-beam welded, resistance seam welded, or brazed around the perimeter to hermetically seal RFS 12 with metallic joints 22. Metallic joints 22 are formed by methods well known in the art, including, but not limited to: resistance seam welding, laser beam welding, electron beam welding, and brazing. RFS 12, formed by the fabrication process discussed above, results in an integral and lightweight thin-walled shell that is hermetically sealed along its periphery by metallic joints 22. In one embodiment, RFS 12 has a thickness of approximately 0.5 mm. Similar bonding or joining processes can be used to fabricate RFS 12 when a relief structure is integrated with support sheet 16 or separator plate 18.

Upon hermetically sealing RFS structure 12 with metallic joints 22, cathode interconnect 24 is connected to RFS 12 at separator sheet 18, as shown in FIG. 2B. Cathode interconnect 24 is positioned directly below separator sheet 18 and is separated from anode interconnect 20 by separator sheet 18. Similar to anode interconnect 20, cathode interconnect 24 is also highly porous and presents very low resistance to oxidant flowing through cathode interconnect 24. The oxidant stream, typically containing oxygen gas flows through cathode interconnect 24 to supply oxygen molecules for electrochemical reactions. The oxidant stream can include, but is not limited to: pure oxygen, air, filtered and purified air, or other oxygen-containing gas streams. Together, RFS 12 and cathode interconnect 24 form what is referred to in the art as a bipolar plate.

Cathode interconnect 24 is formed by bending or corrugating a thin sheet of expanded metal to form a repeating channel structure through which an oxidant stream passes. With the fuel stream hermetically sealed, the oxidant stream can be configured to flow through cathode interconnect 24 by a means of a simple, external “duct-like”, seal-free manifold system. When cathode interconnect 24 is formed from an expanded metal, cathode interconnect 24 has a very low mass density. An additional benefit of using an expanded metal is that it allows minimization of the weight of cathode interconnect 24. In one embodiment, cathode interconnect 24 is formed of the same materials used to form support sheet 16, separator sheet 18, and anode interconnect 20. Cathode interconnect 24 can also be formed from thin-foil bimetallic structures or nickel based super alloys, as long as the alloy being used has sufficient electronic conductivity at the operating temperature of SOFC 10. Additionally, cathode interconnect 24 can also be coated with noble metals and their alloys, including, but not limited to: silver, silver alloys, gold, gold alloys, platinum, platinum alloys, palladium, palladium alloys, rhodium, rhodium alloys, or other noble metals or alloys of noble metals that mitigate the resistive effects of oxide scale and facilitate electron conductivity through cathode interconnect 24.

In another embodiment, cathode interconnect 24 can also be formed from a plurality of elongated filaments arranged similarly to filaments 28 of anode interconnect 20 to form a wire weave pattern. The wire weave pattern is then bent or corrugated to form a repeating channel structure similar when cathode interconnect 24 is formed from the sheet of expanded metal. The main oxidant stream velocity vector is directed parallel to the channel structure in order to minimize pressure drop losses.

In another embodiment, the wire mesh structure can be configured to essentially eliminate the Ohmic resistance that is presented to electron flow by the oxide scale that forms on the external surface of the filaments when the filaments are made of a single, scale-forming alloy. This can be accomplished by electron-conducting filaments in cathode interconnect 24. The electron-conducting filaments have high electron conductivity and do not form a resistive scale in an oxidant atmosphere. The electron-conducting filaments are woven into the wire weave of cathode interconnect 24 and contact both separator sheet 18 and cell 14 to provide a direct, low Ohmic resistance path for the flow of electrons. The electron-conducting filaments are woven into the wire weave in one direction at various locations among the remaining filaments that are formed of stainless steel or other high-strength alloy and that act as structural load-bearing elements in the corrugated wire mesh structure. In one embodiment, the electron-conducting filaments of cathode interconnect 24 can be formed of noble metals and their alloys, including, but not limited to: silver, silver alloys, gold, gold alloys, platinum, platinum alloys, palladium, palladium alloys, rhodium, rhodium alloys, alloys of noble metals with silver, or other noble metals or alloys of noble metals that do not form insulating oxide scales at the operating temperature of SOFC 10 (shown in FIG. 1).

Cathode interconnect 24 is bonded to separator sheet 18 by a suitable bonding process, such as metal-to-metal brazing. Silver, silver alloys, gold, gold alloys, and other noble metal alloys can be used to braze cathode interconnect 24 and separator sheet 18. The noble metals can contain any number of base metals as long as the alloy compositions and the liquid filler metal layer in the resultant joint do not oxidize in air to dielectric oxide compositions. Additionally, the materials used to braze cathode interconnect 24 and separator sheet 18 together should have melting points or liquidus temperatures that can be fabricated with support sheet 16, anode interconnect 20, and separator sheet 18. Cathode interconnect 24 can also be connected to separator sheet 18 by any metal-joining method known in the art, including, but not limited to: laser-beam welding, electron-beam welding, spot welding, and bonding.

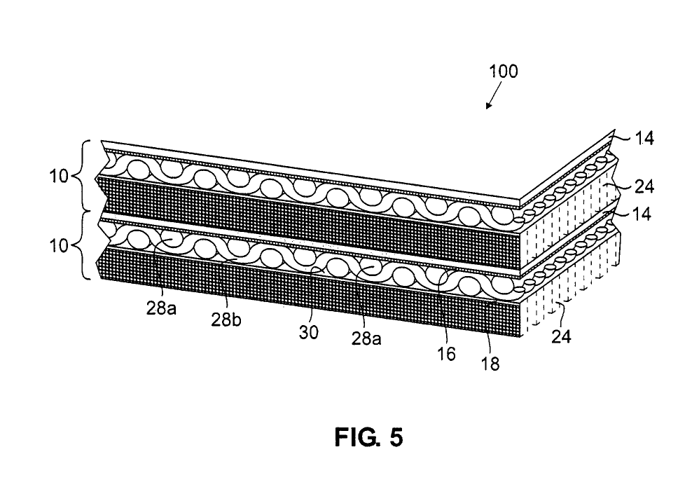

Cathode interconnect 24 is also bonded to cell 14 of an adjacent SOFC 10 to minimize interface Ohmic resistance (shown in FIG. 5). Bonding of cathode interconnect 24 and cell 14 can be achieved by using metallic or ceramic electron-conducting materials that bond to both metal and ceramic. The bonding materials are preferably applied as pastes at ambient conditions and then fired to achieve bonding. Suitable metallic bonding materials include, but are not limited to: silver, silver alloys, gold, gold alloys, platinum, platinum alloys, palladium, palladium alloys, rhodium, rhodium alloys, or alloys of noble metals with suitable base metal components or ceramic materials. Incorporation of base metal components with noble metal bonding materials reduces cost and may enhance bonding of cathode interconnect 24 with cell 14. The incorporation of ceramic materials in a metallic bonding paste, in the form of dispersed powders, limits the densification of the metal powder and enables the bonding layer to retain sufficient porosity, facilitating the diffusion of molecular oxygen diffusion to cell 14. Ceramic materials that can be used to bond cathode interconnect 24 and cell 14 include, but are not limited to: partially or fully stabilized zirconia, alumina, or other stable ceramic powders and ceramic electron-conducting powders, including perovskite materials such as strontium-doped lanthanum manganite, strontium-doped lanthanum cobalt-ferrite, and the like. In one embodiment, noble metal bonding materials are mixed with ceramic electron-conducting powders to bond cathode interconnect 24 to cell 14.

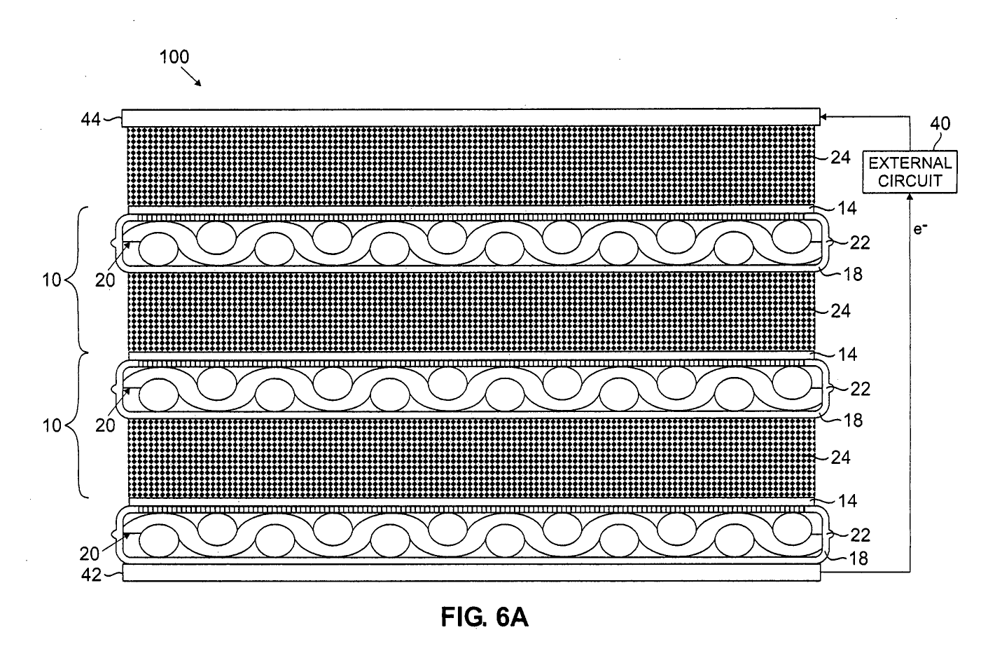

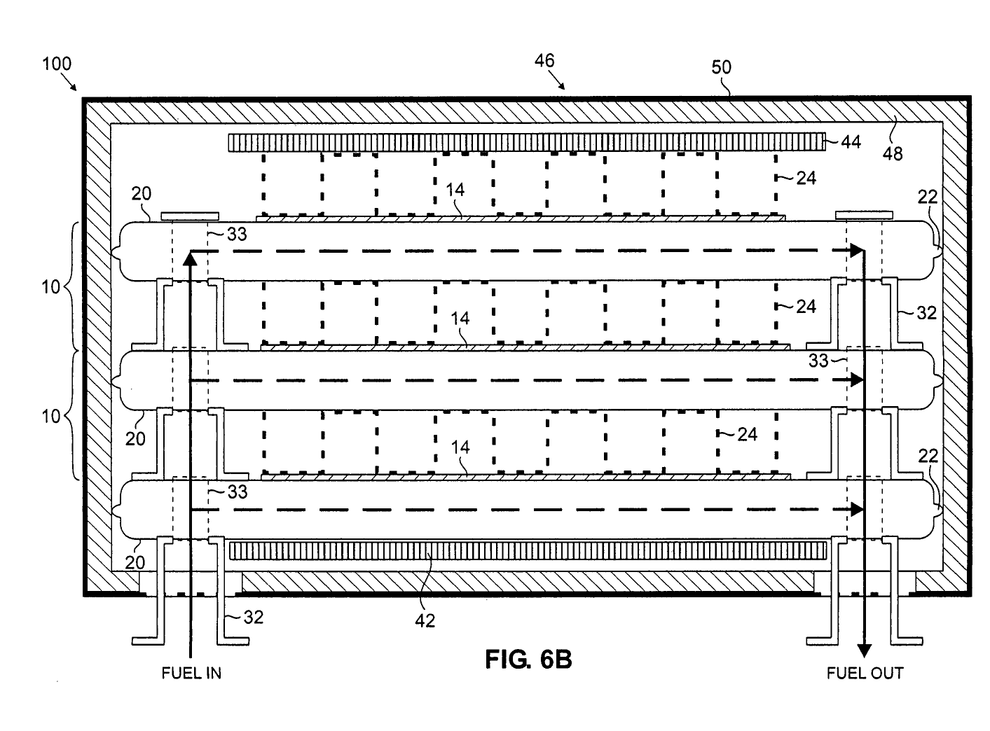

FIG. 2C shows metal support structure 11 rotated 90 degrees from the view shown in FIG. 2B and having fuel manifolds 32. Fuel manifolds 32 are connected to separator sheet 18 of SOFC 10 and to support sheet 16 of an adjacent SOFC 10 (shown in FIG. 6B) at openings 33. Openings 33 are cut through RFS 12 to create open channes through RFS 12 for fuel stream manifolding by a suitable process, such as laser or electron beam slicing. Fuel flows through fuel manifold connectors 32 on one side of SOFCs 10 in an upward direction and is distributed laterally through RFS 12 where it is substantially consumed by cell 14. The reacted fuel then exits through fuel manifold connectors 32 positioned on the opposing side of SOFC 10. At least one of the surfaces of fuel manifold connectors 32 that is bonded to RFS 12 must have a dielectric film in order to prevent cell 14 or cell stack 100 (shown in FIG. 5) from short-circuiting. Electrochemical oxidation enables selective oxidation on a single flat surface so that, for example, only the surface of fuel manifold connector 32 that is to be bonded to support sheet 16 is electrochemically oxidized, while the other opposite surface is kept in the metallic state for metal-to-metal bonding to separator sheet 18. Alternatively, separator sheet 18 or support sheet 16 of adjacent SOFC 10 can have a local dielectric coating. A suitable metal for forming fuel manifold connectors 32 is an aluminum-containing stainless steel that develops an aluminum oxide scale upon oxidation. Examples of particularly suitable stainless steels are Fecralloys, a class of iron-chromium-aluminum stainless steels. An example of a suitable commercially available Fecralloy is Aluchrom Y, available from ThyssenKrupp, Düsseldorf, Germany. The selective oxidation provides flexibility for cell stack fabrication as well as decreased fabrication costs. The dielectric coating can be also be formed of a pre-oxidized or anodized metal.

In one embodiment, fuel manifold connector 32 can be comprised of two sections, which may or may not be formed of the same metal alloy. One of the sections is processed to develop a dielectric film, while the second section remains unprocessed in its metallic state. The two sections are subsequently sealed together during assembly of the fuel cell stack.

The dielectric surface of fuel manifold connectors 32 are attached or bonded to support sheet 16 by brazing with an active metal brazing alloy. Active metal brazing alloys react with ceramic surfaces to form high strength, covalently-bonded joints. This is achieved through the incorporation of active elements, typically Ti, that react with the adjoining ceramic surface to thoroughly wet and bond to the oxide surface. This allows the low weight, high strength, and integrity of a chemical bond to be combined with a dielectric bond to achieve an electrically-isolated hermetic bond. Examples of suitable brazing materials for brazing fuel manifold connectors 32 to support sheet 16 include, but are not limited to: an active metal brazing alloy and a silver-copper oxide composition. In one embodiment, silver-based brazing materials are used. At around 600° C., silver and its alloys are extremely stable and can be used for both sealing and metal-to-metal brazing. Glass or glass-ceramic materials can also be used to bond fuel manifold connectors 32 to RFS 12.

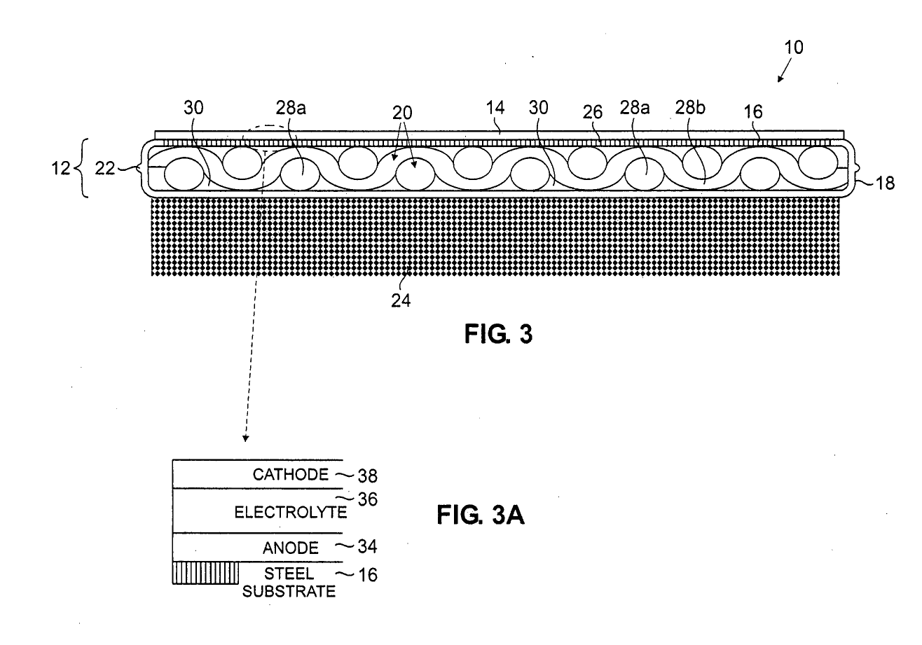

Both FIGS. 3 and 3A depict cell 14 deposited on metal support structure 11 and will be discussed in conjunction with one another. FIG. 3 shows a cross-sectional view of metal support structure 11 with cell 14 deposited on support sheet 16. FIG. 3A shows a magnified view of cell 14. Thick film tri-layer cell 14 includes anode electrode layer 34, electrolyte layer 36, and cathode electrode layer 38. In one embodiment, each of anode electrode layer 34, electrolyte layer 36, and cathode electrode layer 38 has a thickness of between approximately 0.010 mm and approximately 0.1 mm.

Anode electrode layer 34 is directly deposited on support sheet 16 and is in communication with the fuel flowing through anode interconnect 20 through perforations 26 of support sheet 16. In one embodiment, anode electrode layer 34 is formed from a mixture of a metal powder and an oxygen ion conducting ceramic oxide powder, such as nickel and ceria, copper and ceria, or nickel-copper and ceria. Anode electrode layer 34 can also be formed of oxides of nickel, copper, and their alloys mixed with oxygen ion conducting ceramic oxide powders such as doped ceria, doped lanthanum gallate, stabilized zirconia, and the like.

Electrolyte layer 36 is deposited on top of anode electrode layer 34 and is sufficiently dense as to have no interconnected porosity that allows molecular gas diffusion across electrolyte layer 36. Because electrolyte layer 36 does not have interconnected porosity, electrolyte layer 36 acts as a gas barrier between the fuel in communication with anode electrode layer 34 and the oxidant in communication with cathode electrode layer 38. Electrolyte layer 36 also overlaps anode electrode layer 34 to seal off the porous edge of anode electrode layer 34 along the periphery of cell 14. The porous edge of anode electrode layer 34 can also be sealed by applying a glass or glass-ceramic composition along the periphery as long as the composition does not contain any contaminates and has suitable physical and mechanical properties so that the robustness of RFS structure 12 is not affected under transient or steady state conditions. In one embodiment, electrolyte layer 36 is formed from ceria (CeO₂) doped with rare earth (RE) metal oxides. In another embodiment, electrolyte layer 36 is formed from ceria (CeO₂) doped with rare earth (RE) metal oxides and transition metal oxides. One or more RE oxides may be used as dopants. Particularly suitable compositions for electrolyte layer 36 are doubly-doped ceria, as taught in U.S. Pat. No. 5,001,021, and singly-doped RE ceria, such as gadolinia-doped ceria (GDC). Doubly-doped ceria and singly-doped RE ceria allow SOFC 10 to operate at intermediate temperatures of between approximately 500° C. and 600° C. In another embodiment, electrolyte layer 36 can have a composition selected from the class of high ion conductivity doped lanthanum gallates, such as strontium-doped lanthanum gallate, strontium-doped lanthanum magnesium-doped gallate, and the like. In yet another embodiment, electrolyte layer 36 can have a composition selected from the class of partially-stabilized zirconia and fully-stabilized zirconia. If electrolyte layer 36 is chosen from this class, SOFC 10 will need to operate at a higher temperature to achieve a high area power density that is sufficient for applications of limited mission and operational lifetimes.

Cathode electrode layer 38 is deposited on top of electrolyte layer 36 and is in communication with the oxidant flowing through cathode interconnect 24 of an adjacent SOFC 10 (shown in FIG. 5). Similar to electrolyte layer 36, cathode electrode layer 38 can be a composite of the electrolyte materials and strontium-doped lanthanum cobalt ferrite or other highly active mixed ionic-electronic conduction materials.

The ceramic components and electrolytes of cell 14 can be deposited onto support sheet 16 of RFS 12 by suitable ceramic processes known in the art, including, but not limited to: slip casting, tape casting, screen printing, electrophoretic deposition, and spin-coating, followed by bonding and densification by firing and sintering. Cell 14 can also be deposited by other methods, including, but not limited to: thermal plasma spraying, electron-beam physical vapor deposition, sputtering, and chemical vapor deposition

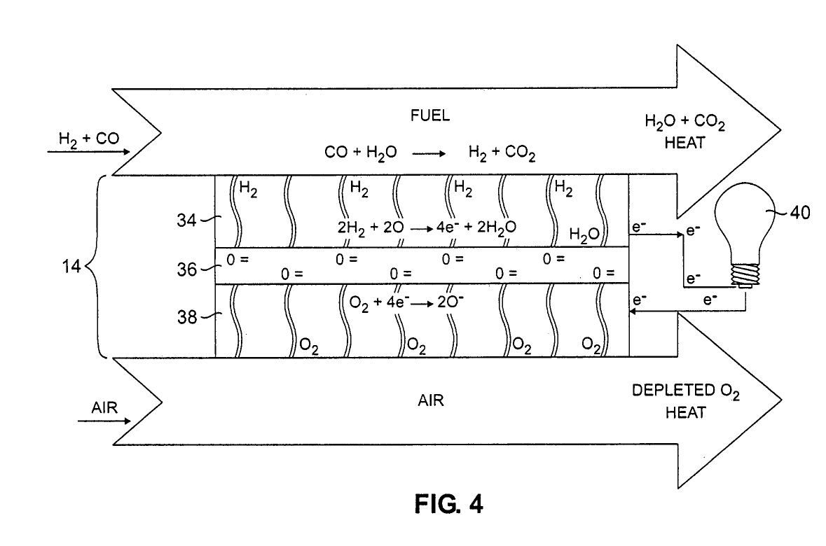

FIG. 4 shows the electrochemical reactions occurring at cell 14 of SOFC 10 and is discussed in conjunction with FIGS. 3 and 3A. In operation, separator sheet 18, metallic joints 22, and electrolyte layer 36 provide a substantially hermetically sealed structure that prevents the fuel and oxidant streams from interacting. As fuel flows through RFS 12, the fuel passes through perforations 26 in support sheet 16 to cell 14 and contacts anode layer electrode 34 and electrolyte layer 36. The carbon monoxide reacts with water to form carbon dioxide and hydrogen, and the hydrogen gas reacts with oxygen ions at electrolyte layer 36 to produce water and electrons. The electrons released in cell 14 flow through filaments 28 of anode interconnect 24 to external circuit 40 to drive an electrical load before traveling back to cathode electrode layer 38. As oxidant flows through cathode interconnect 24, the oxidant contacts cathode electrode layer 38 and electrolyte layer 36. The oxygen in the oxidant stream reacts with electrons at electrolyte layer 36 and is reduced to produce oxygen ions. This cycle continuously repeats as long as there is a steady supply of fuel and a steady supply of oxidant flowing through SOFC 10 and an electrical load is connected to cell 14 through external circuit 40.

FIG. 5 is a perspective cross-sectional view of two SOFCs 10 of cell stack 100, each having metal support structure 11. Current state-of-the-art solid oxide fuel cells have a potential specific power of less than approximately 0.5 kW/kg. SOFC 10 provides a potential specific power greater than approximately 1 kW/kg. This is due primarily to the reduced thickness and light-weight structure of RFS 12. Nevertheless, in order to provide enough power generation capability, a plurality of SOFCs 10 are typically placed in series to form cell stacks, similar to cell stack 100. SOFCs 10 are stacked with respect to one another such that separator sheets 18 prevent fuel flowing through each of anode interconnects 20 from mixing with oxidant flowing through cathode interconnect 24 of an adjacent SOFC 10. In one embodiment, cell stack 100 is formed by first assembling a plurality of SOFCs 10 into a stack structure and then bonding the plurality of SOFCs 10 together. The materials and processes used to bond cathode interconnect 24 to cathode electrode layer 38 and fuel manifold connector 32 to support sheet 16 are selectively chosen to preferably bond the materials over one temperature cycle. Although FIG. 5 depicts only two SOFCs 10 in cell stack 100, cell stack 100 can have any number of SOFCs 10 as needed to provide sufficient power generation for the specified site.

FIG. 6A is cross-sectional view of cell stack 100. When SOFCs 10 are placed in series to form cell stack 100, first metal plate 42 and a second metal plate 44 are positioned below and above cell stack 100, respectively, to act as current collectors and provide minimal resistance for electrons to travel to and from external circuit 40. Similarly to when there is only one SOFC 10, separator sheets 18, metallic joints 22, and electrolyte layers 36 (shown in FIGS. 3 and 3A) of each of SOFCs 10 of cell stack 100 prevent the fuel and oxidant streams from interacting. The fuel flowing through anode interconnects 20 and the oxidant flowing through cathode interconnects 24 interact in the same manner, forming water and releasing electrons from the hydrogen in the fuel stream and using the electrons that return to cell stack 100 via external circuit 40 to reduce the oxygen molecules in the oxidant stream. However, in cell stack 100, instead of passing the electrons released in each of cells 14 through filaments 28 (shown in FIG. 3) of anode interconnect 20 to external circuit 40, the electrons travel down through filaments 28 of anode interconnect 20, through separator sheet 18, and through cathode interconnect 24 to cathode layer 38 of an adjacent SOFC 10. When the electrons contact first metal plate 42 at the bottom of cell stack 100, the electrons travel to external circuit 40 to provide energy and then return to second metal plate 44 on the opposing end of cell stack 100. The electrons then flow through cathode interconnect 24 contacting second metal plate 44 to repeat the cycle and provide electric power to external circuit 40.

FIG. 6B is a schematic cross-sectional view of cell stack 100 rotated 90 degrees from the view shown in FIG. 6A and positioned in thermally insulated, oxidant-filled chamber 36. Chamber 46 provides a seal-free manifold for the oxidant stream flowing through SOFCs 10 of cell stack 100 and includes thermal insulation 48 and sleeve 50. Chamber 46 manages the oxidant stream for cell stack 100 by inlet and outlet plenums (not shown). Insulation 48 is a thermally insulating material that fits tightly over cell stack 100 in order to direct the oxidant to pass through cathode interconnects 24 and minimize the fraction of oxidant that by-passes cell stack 100. In one embodiment, insulation 48 is formed from fibrous ceramic that is either dielectrically or electrically insulating and can be formed from a variety of materials, including, but not limited to: Fiberfax®, fibrous alumina, woven alumina fibers, or any combination thereof. Sleeve 50 is preferably formed of metal and surrounds insulation 48. Although FIG. 6B depicts the oxidant stream flow through cathode interconnects 24 configured in a counter-flow pattern relative to the fuel stream flow through anode interconnects 20, the oxidant and fuel stream flows can be configured in any of the classic counter-flow, co-flow, or cross-flow patterns.

The solid oxide fuel cell of the present invention has a rigidized foil support (RFS) for supporting a thick film tri-layer cell. The electrolyte used in the tri-layer cell is a rare-earth-doped ceria, and particularly gadolinia-doped ceria, allowing the solid oxide fuel cell to operate at temperatures below approximately 600° C. As a result, the RFS can be formed of less expensive materials that are durable at these temperatures, specifically stainless steel alloys such as ferritic stainless steel and other high-chromium alloys. Due to the use of a low thermal mass cell and a RFS, the solid oxide fuel cell can also be rapidly heated to an operating temperature of approximately 600° C. and significantly shorten the start-up time of the fuel cell.

The RFS includes a support sheet, an anode interconnect, and a separator sheet bonded together to form a thin and lightweight structure, with the cell deposited directly on top of the support sheet. A cathode interconnect is also connected to the separator sheet. The support sheet is perforated so that fuel flowing through the anode interconnect comes into contact with the cell. The separator sheet is a solid sheet of metal and maintains the fuel flowing through the void spaces of the anode interconnect and the oxidant flowing through the void spaces of the cathode interconnect separate from each other in a reliable and robust manner.

A solid oxide fuel cell incorporating the RFS is about three times thinner than current state-of-the-art planar solid oxide fuel cells that use the anode electrode layer as the cell support. Despite the significant reduction in thickness, the RFS cell-supporting structure incorporates the functions of a cell support, an anode interconnect, void spaces for fuel flow, and a separator plate. Additionally, the ductility of the metal forming the RFS enables the formation of very thin foils, which typically deform and warp easily, and, at large footprint scales, do not provide rigid support for the brittle ceramic cell. However, the bonded RFS is a “reinforced” structure, strengthened by the interconnected filaments or other geometric constructs of the porous structure for the anode interconnects. The RFS thus provides sufficient resistance to out-of-plane deformation and provides excellent support for the SOFC trilayer.

The metallic RFS can also be made into large footprints by continuous, semi-batch, or batch metal-working processes. RFS footprint sizes in excess of 300 mm×300 mm are expected to provide significant advantages compared to planar SOFC cells supported by ceramic supports, which are limited to sizes smaller than 200 mm×200 mm due to current limitations of ceramic manufacturing processes and process yields. The RFS also exhibits controllable geometry and porosity features that can be designed and implemented with very high precision and reliability. These features translate to well-controlled fuel gas flow resistance and essentially uniform fuel distribution in multi-cell stacks.

Although the present invention has been described with reference to preferred embodiments, workers skilled in the art will recognize that changes may be made in form and detail without departing from the spirit and scope of the invention.

1. A metallic, rigidized foil support structure for supporting a cell of a solid oxide fuel cell, the support structure comprising:
a separator sheet;
a support sheet having perforations configured to communicate a fluid; and
a porous layer located between the separator sheet and the support sheet for providing support and reinforcement to the support structure, providing electrical connection between the support sheet and the separator sheet, and allowing fluid flow through the porous layer.

2. The support structure of claim 1, wherein the cell is directly supported by the support sheet.

3. The support structure of claim 1, wherein the support sheet is substantially hermetically sealed to the separator sheet.

4. The support structure of claim 1, wherein the support sheet and the separator sheet are formed from a single sheet of foil.

5. The support structure of claim 1, wherein the porous layer is formed from a plurality of filaments configured in a wire weave pattern.

6. The support structure of claim 1, wherein the porous layer is a relief structure and is integral to the separator sheet.

7. The support structure of claim 1, wherein the separator sheet, the support sheet, and the porous layer are formed of high-chromium stainless steel.

8. The support structure of claim 1, wherein the support structure has a thickness of less than 1 millimeter.

9. The support structure of claim 1, wherein the support structure has an area mass density of less than 0.4 g/cm².

10. A high specific power solid oxide fuel cell stack having a plurality of repeat units, each of the repeat units of the solid oxide fuel cell stack comprising:
a metallic, rigidized foil support structure positioned to support the fuel cell, the support structure comprising:
a perforated support sheet;
a separator sheet; and
a porous layer positioned between the perforated support sheet and the separator sheet for providing support and reinforcement to the support structure and for providing electrical connection between the support sheet and the separator sheet;
a tri-layer solid oxide fuel cell deposited on the perforated support sheet of the rigidized foil support structure; and
a cathode interconnect.

11. The fuel cell stack of claim 10, wherein the tri-layer solid oxide fuel cell comprises ceria doped with rare earth metal oxides.

12. The fuel cell stack of claim 11, wherein the tri-layer solid oxide fuel cell comprises ceria doped with rare earth metal oxides and transition metal oxides.

13. The fuel cell stack of claim 11, wherein an electrolyte layer of the tri-layer solid oxide fuel cell is selected from the group consisting of: gadolinia-doped ceria, strontium-doped lanthanum gallate, strontium-doped lanthanum magnesium-doped gallate, and partially-stabilized and fully-stabilized zirconia.

14. The fuel cell stack of claim 10, wherein the cathode interconnect is formed from a sheet of expanded metal or a plurality of filaments configured in a mesh structure.

15. The fuel cell stack of claim 14, wherein the cathode interconnect is formed of stainless steel.

16. The fuel cell stack of claim 10, wherein at least a portion of the cathode interconnect comprises a high electron conducting material.

17. The fuel cell stack of claim 10, wherein porous layer is formed from a plurality of filaments configured in a wire weave pattern.

18. The fuel cell stack of claim 10, wherein the fuel cell stack has a specific power of at least 0.5 kilowatt per kilogram.

19. The fuel cell stack of claim 10, wherein the rigidized foil support structure has a thickness of less than 1 millimeter.

20. The fuel cell stack of claim 10, and further comprising a manifold structure configured to communicate fuel to the porous layer.

21. The fuel cell stack of claim 10, and further comprising an oxidant fluid-filled chamber, wherein the solid oxide fuel cell stack is housed within the oxidant fluid-filled chamber, and wherein the chamber allows the cathode interconnect to be in open communication with the oxidant fluid.

22. The fuel cell stack of claim 21, wherein oxidant continuously flows through the fluid-filled chamber.

23. A method of fabricating a solid oxide fuel cell stack having a metal support structure, the method comprising:
forming a plurality of perforations in a first sheet of foil;
positioning a reinforcement mesh structure between the first sheet of foil and a second sheet of foil;
bonding the first sheet of foil, the second sheet of foil, and the reinforcement mesh structure;
forming a hermetic seal between the first sheet of foil and the second sheet of foil; and
depositing a thick film tri-layer cell on a first side of the first sheet of foil.

24. The method of claim 23, wherein forming the hermetic seal comprises electron-beam welding, laser-beam welding, resistance welding, or brazing.

25. The method of claim 23, wherein bonding the first and second sheets of foil to the reinforcement mesh structure comprises diffusion bonding, resistance welding, or brazing the first and second sheets of foil to the reinforcement mesh structure.

26. The method of claim 23, wherein the first sheet of foil and the second sheet of foil are formed from a primary sheet of foil having a first half and a second half.

27. The method of claim 26, wherein bonding the first sheet of foil, the second sheet of foil, and the reinforcement mesh structure comprises folding the first half of the sheet of foil over the second half of the sheet of foil with the reinforcement mesh structure positioned between the first and second halves of the sheet of foil.
